(19) United States
(12) Patent Application Publication
(10) Pub. No.: US 2014/0184444 A1
(43) Pub. Date: Jul. 3, 2014

(54) COMMUNICATION DEVICE AND SWITCHING METHOD

(71) Applicant: Fujitsu Mobile Communications Limited, Kawasaki-shi (JP)

(72) Inventor: Jiro ISHIKAWA, Kawasaki (JP)

(73) Assignee: Fujitsu Mobile Communications Limited, Kawasaki-shi (JP)

(21) Appl. No.: 14/043,938

(22) Filed: Oct. 2, 2013

(30) Foreign Application Priority Data
Dec. 28, 2012 (JP) 2012-289139

(51) Int. Cl. G01S 19/34

(52) U.S. Cl. CPC G01S 19/34
USPC 342/357.74

(57) ABSTRACT

An antenna receives a radio wave transmitted from a GPS satellite. A wireless processing unit extracts positioning information from a signal of the radio wave received by the antenna. The positioning unit performs positioning on the basis of the positioning information extracted by the wireless processing unit. A transformer circuit includes a switching element and transforms supplied power to a predetermined voltage. A switching unit switches the transformer circuit to a stop state during an extraction period in which the positioning information is extracted by the wireless processing unit.

### CROSS-REFERENCE TO RELATED APPLICATIONS

This application is based upon and claims the benefit of priority of the prior Japanese Patent Application No. 2012-289139, filed on Dec. 28, 2012, the entire contents of which are incorporated herein by reference.

### FIELD

The embodiments discussed herein are related to a communication device and a switching method.

### BACKGROUND

There are communication devices in which a Global Positioning System (GPS) is mounted and which can perform positioning of their own position. Examples of such communication devices include a smartphone, a mobile phone, and a Personal Digital Assistants (PDA). Further, there are communication devices which include a battery. In such a communication device, electric power supplied from outside through a cable is transformed into a predetermined voltage to be used inside the communication device by a transformer circuit and a battery is charged by the voltage. As such a transformer circuit, for example, there is a DC/DC converter.

By the way, when the communication device transforms the electric power supplied through a cable into a predetermined voltage by the transformer circuit, electromagnetic noise is radiated by ON/OFF of a switching element included in the transformer circuit. Further, electromagnetic noise may be radiated from the cable through which the electric power is supplied to the communication device. The electromagnetic noise is also referred to as Electro-Magnetic Interference (EMI).

In the communication device, the radiated electromagnetic noise may be superimposed on a radio wave from a GPS satellite and detected, so that the positioning performance may degrade. Therefore, in order to successfully and preferentially perform first positioning which is relatively susceptible to noise, there is a conventional technique that stops functions, which is other than the GPS function and which generate noise, for several minutes.
Patent Literature 1: Japanese Laid-open Patent Publication No. 2011-220945

However, the conventional technique has a problem in which if charging and positioning are performed in parallel after the first positioning, the positioning performance degrades due to influence of the electromagnetic noise.

### SUMMARY

According to an aspect of an embodiment, a communication device includes: an antenna that receives a radio wave transmitted from a GPS satellite; an extraction unit that extracts positioning information from a signal of the radio wave received by the antenna: a positioning unit that performs positioning on the basis of the positioning information extracted by the extraction unit; a transformer circuit that includes a switching element and transforms supplied power to a predetermined voltage; and a switching unit that switches the transformer circuit to a stop state during an extraction period in which the positioning information is extracted by the extraction unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an entire configuration of a communication device according to a first embodiment;

FIG. 2 is a diagram for explaining a control flow when positioning is performed;

FIG. 3 is a diagram illustrating a change of state of a transformer circuit;

FIG. 4 is a flowchart illustrating a procedure of a switching process according to the first embodiment;

FIG. 5 is a diagram illustrating an entire configuration of a communication device according to a second embodiment;

FIG. 6 is a graph schematically illustrating a relationship between a signal level of a signal of a radio wave inputted from an antenna and an extraction period of positioning information;

FIG. 7 is a flowchart illustrating a procedure of a switching process according to the second embodiment;

FIG. 8 is a diagram for explaining determination of switching;

FIG. 9 is a flowchart illustrating a procedure of a switching process according to a third embodiment; and

FIG. 10 is a diagram illustrating a computer that executes a switching program.

### DESCRIPTION OF EMBODIMENTS

Preferred embodiments of the present invention will be explained with reference to accompanying drawings.

The present invention is not limited by the embodiments. The respective embodiments can be appropriately combined with each other within a range where the processing contents are not contradictory to each other.

### [a] First Embodiment

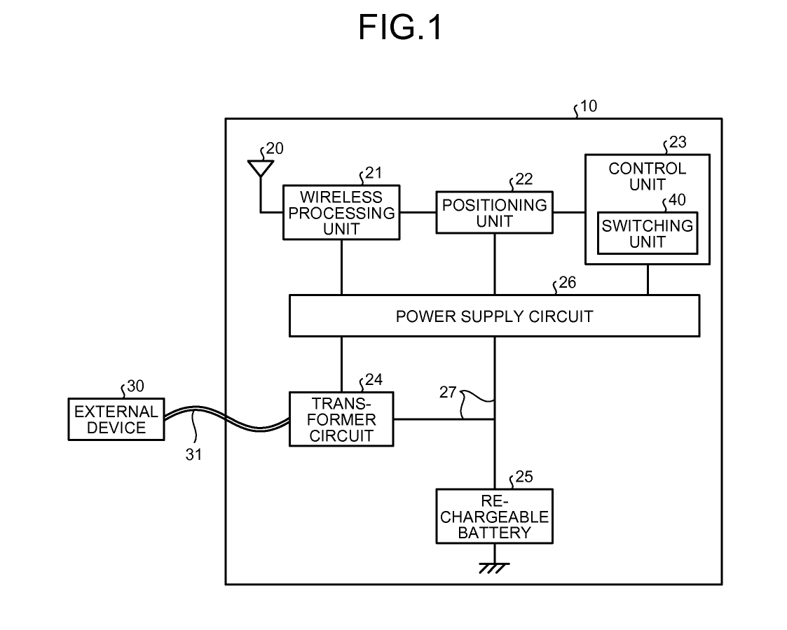

A first embodiment will be described. FIG. 1 is a diagram illustrating an entire configuration of a communication device according to the first embodiment. a communication device 10 can communicate with another device through a network not illustrated in FIG. 1. Examples of such a communication device 10 include a smartphone, a mobile phone, and a PDA. Examples of the network include any communication network such as a Wireless Local Area Network (wireless LAN) and a mobile communication network. The communication device 10 can perform positioning by receiving radio waves from GPS satellites. As illustrated in FIG. 1, the communication device 10 includes an antenna 20, a wireless processing unit 21, a positioning unit 22, a control unit 23, a transformer circuit 24, a rechargeable battery 25, and a power supply circuit 26.

The antenna 20 is a device that receives radio waves transmitted from the GPS satellites. In the GPS, a plurality of GPS satellites go around the Earth in a plurality of orbits. For example, four GPS satellites go around the Earth in each of six orbits. Each GPS satellite holds accurately synchronized time. Each GPS satellite periodically transmits positioning information by a radio wave. For example, each GPS satellite transmits data, which is obtained by phase-modulating a navigation message including time information held by the GPS satellite, ephemeris data that indicates the position of the GPS satellite itself, and almanac data that indicates an orbit of another GPS satellite by a code unique to each GPS satellite, by a radio wave of a predetermined frequency band. The antenna 20 receives a radio wave transmitted from each GPS satellite and converts the received radio wave into a signal.

The wireless processing unit 21 is a device that extracts the positioning information from the signal of the radio wave received by the antenna 20. Electric power is supplied to the wireless processing unit 21 from the power supply circuit 26. The state of the wireless processing unit 21 can be switched by turning on/off the power supplied from the power supply circuit 26. When the power is supplied to the wireless processing unit 21, the wireless processing unit 21 extracts the positioning information from the signal of the radio wave inputted from the antenna 20. For example, the wireless processing unit 21 amplifies the signal converted by the antenna 20 and converts the signal into digital data. Then the wireless processing unit 21 extracts the positioning information from the digital data by using the code unique to each GPS satellite. For example, the wireless processing unit 21 identifies a phase control amount where the digital code and the unique code are similar to each other by comparing the digital data with the unique code while changing the phase. For example, the wireless processing unit 21 identifies a phase control amount where the correlation between the digital data and the unique code is the highest. Then the wireless processing unit 21 obtains a navigation message by demodulating the digital data by using the unique code at the phase position of the phase control amount. The wireless processing unit 21 includes a clock such as, for example, Real Time Clock (RTC) and obtains a propagation time of the radio wave from each GPS satellite from the receiving time of the data and the time information in the navigation message. Then the wireless processing unit 21 outputs the navigation message and the propagation time of the radio wave from the GPS satellite to the positioning unit 22 as the positioning information.

The positioning unit 22 is a device that performs positioning on the basis of the positioning information. Electric power is supplied to the positioning unit 22 from the power supply circuit 26. The state of the positioning unit 22 can be switched by turning on/off the power supplied from the power supply circuit 26. When the power is supplied to the positioning unit 22 and a sufficient number of pieces of positioning information to perform positioning are inputted from the wireless processing unit 21, the positioning unit 22 notifies the control unit 23 that the positioning unit 22 receives the positioning information. The positioning unit 22 performs positioning on the basis of the inputted positioning information. For example, the positioning unit 22 obtains a distance to each GPS satellite by multiplying the propagation time of the radio wave from each GPS satellite by the light speed. Then the positioning unit 22 performs positioning by using the positions of the GPS satellites included in the navigation messages and the distances to the GPS satellites. Here, when performing the positioning by assuming that the clock included in the wireless processing unit 21 includes a time error, the positioning unit 22 calculates the time error and the position by using the navigation messages from four or more GPS satellites and the distances to the GPS satellites. Then the positioning unit 22 outputs the calculated position information to the control unit 23.

If the time error has been obtained once, the positioning unit 22 may calculate the position by using the obtained time error and the navigation messages from three GPS satellites and the distances to the GPS satellites. Further, the positioning unit 22 converts the positioned position to a geodetic reference system of latitude, longitude, and altitude, and if performing the positioning by assuming that the altitude does not change, the positioning unit 22 may calculate the position in the geodetic reference system by using the navigation messages from two GPS satellites and the distances to the GPS satellites. In other words, the positioning unit 22 does not necessarily need the navigation messages from four GPS satellites and the distances to the GPS satellites to perform the positioning. The wireless processing unit 21 may obtain the distance to the GPS satellite by multiplying the propagation time by the light speed and output the distance to the GPS satellite to the positioning unit 22 as the positioning information.

Further, the position information of the GPS satellite may be obtained from other than the GPS satellite. The data transmission rate of the GPS satellite is as low as, for example, 50 bps, so that it takes, for example, 30 seconds to acquire the ephemeris data. Therefore, when the communication device 10 is compatible with an Assisted GPS (A-GPS) function, the communication device 10 may acquire the almanac data and the ephemeris data by data communication through the mobile communication network. When the communication device 10 acquires the almanac data and the ephemeris data through the mobile communication network in this way, the wireless processing unit 21 may output the propagation time of the radio wave or the distance to the GPS satellite to the positioning unit 22 as the positioning information.

The control unit 23 is a device that controls the communication device 10. As the control unit 23, an electronic circuit such as a Central Processing Unit (CPU) and a Micro Processing Unit (MPU) and an integrated circuit such as Application Specific Integrated Circuit (ASIC) and Field Programmable Gate Array (FPGA) can be employed. The control unit 23 has an internal memory for storing programs that define various processing procedures and control data and performs various processes by the programs and the control data. The various programs run, thereby the control unit 23 functions as various processing units. For example, the control unit 23 includes a switching unit 40. Various application programs run in the control unit 23. Some application programs request the position information. For example, a navigation program periodically requests the position information to display the current position on a map.

The switching unit 40 performs various switching operations. For example, the switching unit 40 receives a request of the position information from an application program. When the switching unit 40 receives a request of the position information, the switching unit 40 instructs the power supply circuit 26 to supply power to the wireless processing unit 21 and the positioning unit 22 and switches the wireless processing unit 21 and the positioning unit 22 to an operating state. When the switching unit 40 receives a notice of receiving the positioning information from the positioning unit 22, the switching unit 40 instructs the power supply circuit 26 to stop the power supply to the wireless processing unit 21 and switches the wireless processing unit 21 to a stop state. When the switching unit 40 receives the position information from the positioning unit 22, the switching unit 40 instructs the power supply circuit 26 to stop the power supply to the positioning unit 22 and switches the positioning unit 22 to a stop state. In other words, when performing the positioning, the switching unit 40 switches the wireless processing unit 21 and the positioning unit 22 to the operating state and after the completion of the processes of the wireless processing unit 21 and the positioning unit 22, the switching unit 40 switches the wireless processing unit 21 and the positioning unit 22 to the stop state.

Further, the switching unit 40 switches the transformer circuit 24 described later to a stop state during an extraction period in which the positioning information is extracted by the wireless processing unit 21. For example, when the switching unit 40 receives a request of the position information, the switching unit 40 instructs the transformer circuit 24 to stop and switches the transformer circuit 24 to a stop state. When the switching unit 40 receives a notice of receiving the positioning information from the positioning unit 22, the switching unit 40 instructs the transformer circuit 24 to start operation and switches the transformer circuit 24 to an operating state.

The transformer circuit 24 is a device that transforms supplied power to a predetermined voltage. The transformer circuit 24 includes a switching element and transforms supplied power to a predetermined voltage by turning on and off the switching element. Examples of such a transformer circuit 24 include various circuits such as a DC/DC converter. It is possible to switch the transformer circuit 24 to an operating state in which the switching element is turned on and off and the supplied power is transformed to a predetermined voltage and a stop state in which the switching element is stopped and the voltage transformation is not performed by an instruction from the control unit 23. The transformer circuit 24 is connected to the rechargeable battery 25 and the power supply circuit 26 by a power supply line 27. When the rechargeable battery 25 is charged, the transformer circuit 24 is connected to an external device and power is supplied to the transformer circuit 24. For example, when the rechargeable battery 25 is charged, the transformer circuit 24 is connected to an external device 30 such as, for example, a personal computer (PC) by a cable 31 such as, for example, a Universal Serial Bus (USB) cable. The external device 30 supplies, for example, power of 5 V through the cable 31. The transformer circuit 24 lowers the power supplied through the cable 31 to, for example, 4.2 V and supplies the power to the power supply line 27. The external device 30 may be any device that can supply power. For example, the external device 30 is assumed to be a power supply circuit of a vehicle or the like and the power may be supplied from a cigarette lighter socket through the cable 31.

The rechargeable battery 25 is a device that can accumulate electricity by charging the device. The rechargeable battery 25 is frame-grounded to a frame of the communication device 10. When power is supplied to the rechargeable battery 25 from the transformer circuit 24 through the power supply line 27, the power supplied from the transformer circuit 24 is accumulated. When the power supply from the transformer circuit 24 stops, the rechargeable battery 25 discharges the accumulated electricity. As the rechargeable battery 25, a lithium-ion battery, a nickel-hydrogen battery, a nickel-cadmium battery, and the like can be employed.

The power supply circuit 26 is a device that supplies power to electrical devices in the communication device 10. The power supply circuit 26 supplies the power supplied to the power supply line 27 to the wireless processing unit 21, the positioning unit 22, and the control unit 23 described above. In the power supply circuit 26, for example, a switch is provided to a line that supplies power to the wireless processing unit 21 and the positioning unit 22, and it is possible to switch the power to the wireless processing unit 21 and the positioning unit 22 to a supply state or a supply stop state by turning on and off the switch. The power supply circuit 26 switches the power supply to the wireless processing unit 21 and the positioning unit 22 by turning on and off the switch according to the instruction from the control unit 23.

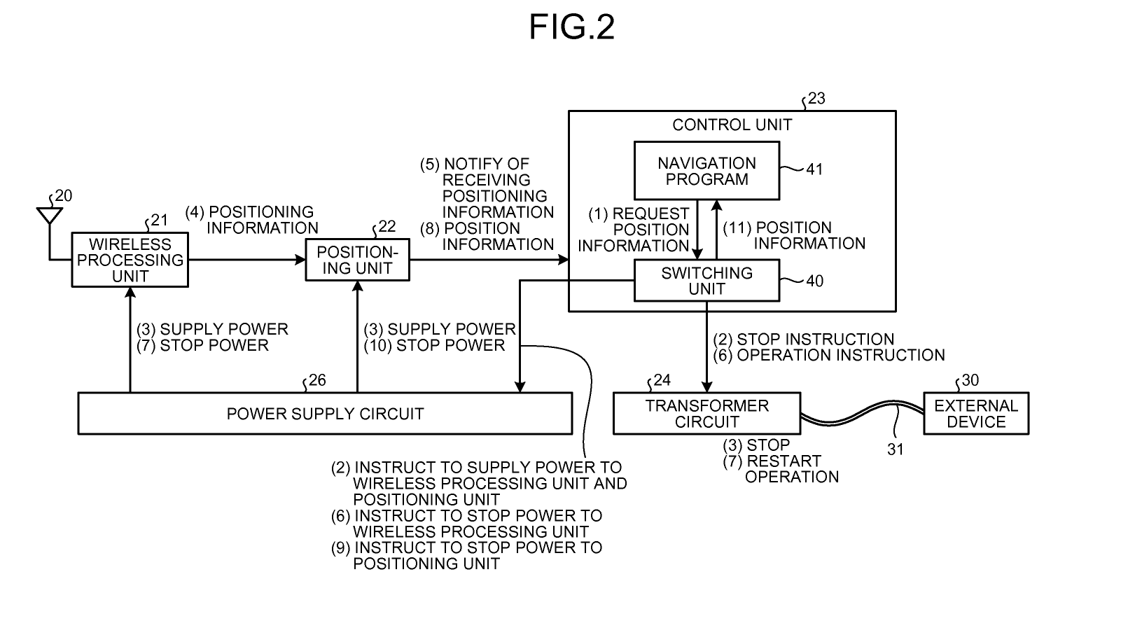

FIG. 2 is a diagram for explaining a control flow when the positioning is performed. Regarding the communication device 10, when the rechargeable battery 25 is charged, the external device 30 and the transformer circuit 24 are connected by the cable 31. Thereby, for example, the power of 5 V is supplied to the transformer circuit 24 from the external device 30 through the cable 31. The transformer circuit 24 lowers, for example, the power of 5 V supplied through the cable 31 to, for example, 4.2 V. When the transformer circuit 24 lowers the voltage of the supplied power, electromagnetic noise is radiated by the turning on and off the switching element included in the transformer circuit 24. Further, an electric current intermittently flows in the cable 31 by turning on and off the switching element included in the transformer circuit 24, so that electromagnetic noise is radiated.

On the other hand, various application programs run in the communication device 10 and when an application program uses the position information, the application program requests the position information. For example, a navigation program 41 periodically requests the position information to display the current position on a map.

When the position information is requested, the switching unit 40 instructs the power supply circuit 26 to supply power to the wireless processing unit 21 and the positioning unit 22. When the switching unit 40 receives a request of the position information, the switching unit 40 instructs the transformer circuit 24 to stop.

When the power supply circuit 26 is instructed by the control unit 23 to supply power to the wireless processing unit 21 and the positioning unit 22, the power supply circuit 26 supplies power to the wireless processing unit 21 and the positioning unit 22. When the transformer circuit 24 is instructed by the control unit 23 to stop, the transformer circuit 24 stops transformation by turning off the switching element. Thereby, the electromagnetic noise is not radiated from the transformer circuit 24. When the transformer circuit 24 stops, the electric current does not flow in the cable 31. Therefore, also, the electromagnetic noise is not radiated from the cable 31.

When the power is supplied to the wireless processing unit 21, the wireless processing unit 21 extracts the positioning information from the signal of the radio wave inputted from the antenna 20 and outputs the extracted positioning information to the positioning unit 22.

When the power is supplied to the positioning unit 22, the positioning unit 22 becomes the operating state, and when a sufficient number of pieces of positioning information to perform the positioning are inputted into the positioning unit 22 from the wireless processing unit 21, the positioning unit 22 notifies the control unit 23 that the positioning unit 22 receives the positioning information. For example, when the positioning information of four GPS satellite is inputted into the positioning unit 22 from the wireless processing unit 21, the positioning unit 22 notifies the control unit 23 that the positioning unit 22 receives the positioning information.

When the switching unit 40 receives a notice of receiving the positioning information from the positioning unit 22, the switching unit 40 instructs the power supply circuit 26 to stop the power supply to the wireless processing unit 21. When the switching unit 40 receives the notice of receiving the positioning information from the positioning unit 22, the switching unit 40 instructs the transformer circuit 24 to start operation.

When the power supply circuit 26 is instructed by the control unit 23 to stop the power supply to the wireless processing unit 21, the power supply circuit 26 stops the power supply to the wireless processing unit 21. When the transformer circuit 24 is instructed by the control unit 23 to start operation, the transformer circuit 24 restarts the operation and lowers, for example, the power of 5 V supplied through the cable 31 to, for example, 4.2 V.

The positioning unit 22 performs the positioning on the basis of the inputted positioning information and outputs position information indicating the positioned position to the control unit 23.

When the switching unit 40 receives the position information from the positioning unit 22, the switching unit 40 instructs the power supply circuit 26 to stop the power supply to the positioning unit 22.

When the power supply circuit 26 is instructed by the control unit 23 to stop the power supply to the positioning unit 22, the power supply circuit 26 stops the power supply to the positioning unit 22.

An application program running in the control unit 23 performs a display based on the inputted position information. For example, the navigation program 41 displays a position indicated by the position information on a map as the current position.

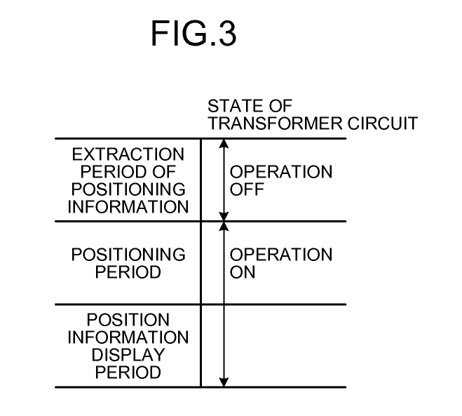

FIG. 3 is a diagram illustrating a change of the state of the transformer circuit. As illustrated in FIG. 3, the transformer circuit 24 is in the stop state during the extraction period in which the positioning information is extracted by the wireless processing unit 21. In the communication device 10, the transformer circuit 24 is stopped during the extraction period in which the positioning information is extracted, so that radiation noise is not generated. Therefore, it is possible to suppress the degradation of the positioning performance.

On the other hand, the transformer circuit 24 is in the operating state during a positioning period in which the positioning is performed from the positioning information and a display period in which an application program displays the position based on the position information. In the communication device 10, it is possible to charge the rechargeable battery 25 by causing the transformer circuit 24 to operate during the positioning period and the display period.

Here, the communication device 10 that can perform positioning by the GPS may be used as a car navigation system or the like, so that even while charging, the navigation program may be operated to perform positioning. When the communication device 10 performs positioning while charging, the electromagnetic noise is generated from the transformer circuit 24 and a charging cable such as the cable 31 and the generated electromagnetic noise is superimposed on the radio wave from the GPS satellite and detected by the antenna 20, so that the positioning performance may degrade. To reduce the influence of the electromagnetic noise, a designer makes a design so that antennas of all wireless systems mounted in the communication device 10 are away from the transformer circuit 24 and a USB connector. On the other hand, the communication device 10 may be requested to be downsized. The communication device 10 such as a smartphone, a mobile phone, and a PDA is requested to be downsized. When downsizing the communication device 10, it is difficult for the designer to arrange antennas of all the wireless systems mounted in the communication device 10 sufficiently far away from the transformer circuit 24 and the USB connector. Therefore, some communication systems are arranged close to the transformer circuit 24 or the USB connector. For example, in the case of a smartphone, a mobile phone, and the like, an antenna used for a phone call and data communication, which are major functions, is arranged away from the transformer circuit 24 and the USB connector. On the other hand, the antenna 20 for the GPS is arranged close to the transformer circuit 24 or the USB connector. Even when the antenna 20 for the GPS is arranged close to the transformer circuit 24 or the USB connector in this way, in the communication device 10, the transformer circuit 24 is switched to the stop state during the extraction period in which the positioning information is extracted, so that it is possible to suppress the degradation of the positioning performance. Further, in the communication device 10, the power consumed by the positioning is smaller than that consumed by other communication systems such as a phone call and data communication. Therefore, in the communication device 10, even if charging is temporarily stopped while charging, it is possible to supply power from the rechargeable battery 25.

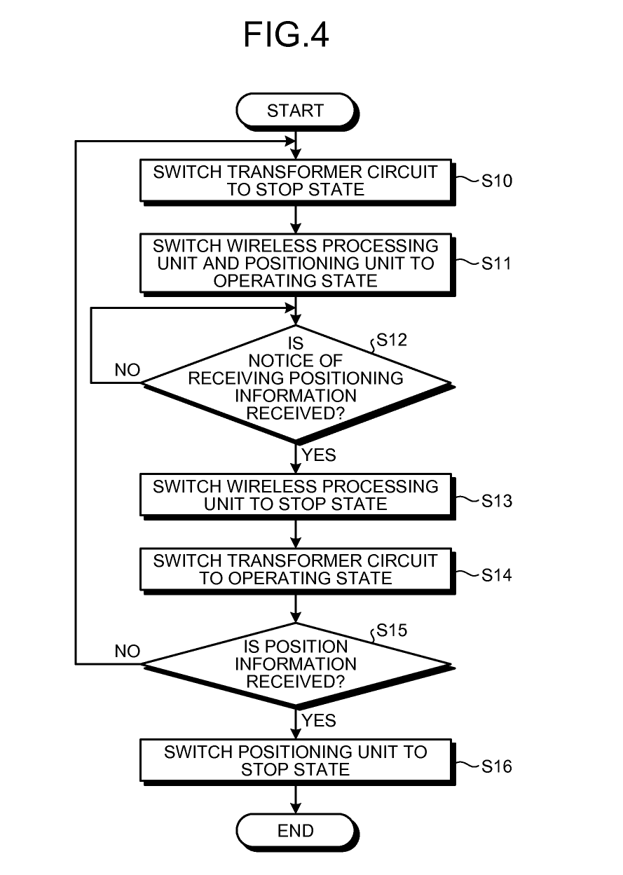

Next, a flow of a switching process will be described in which the communication device 10 according to the present embodiment switches the state of the transformer circuit 24. FIG. 4 is a flowchart illustrating a procedure of the switching process according to the first embodiment. The switching process is performed, for example, at a timing when the position information is requested from an application program.

As illustrated in FIG. 4, the switching unit 40 instructs the transformer circuit 24 to stop and switches the transformer circuit 24 to the stop state (S10). The switching unit 40 instructs the power supply circuit 26 to supply power to the wireless processing unit 21 and the positioning unit 22 and switches the wireless processing unit 21 and the positioning unit 22 to the operating state (S11). Then, the switching unit 40 determines whether or not a notice of receiving the positioning information is received from the positioning unit 22 (S12). If the notice of receiving the positioning information is not received (S12: No), the switching unit 40 proceeds to S12 again and waits for a notice of receiving the positioning information.

On the other hand, if the notice of receiving the positioning information is received (S12: Yes), the switching unit 40 instructs the power supply circuit 26 to stop the power supply to the wireless processing unit 21 and switches the wireless processing unit 21 to the stop state (S13). Further, the switching unit 40 instructs the transformer circuit 24 to start operation and switches the transformer circuit 24 to the operating state (S14). Then, the switching unit 40 determines whether or not the position information is received from the positioning unit 22 (S15). If the position information is not received (S15: No), the switching unit 40 proceeds to S10 again and continues the process.

On the other hand, if the position information is received (S15: Yes), the switching unit 40 instructs the power supply circuit 26 to stop the power supply to the positioning unit 22, switches the positioning unit 22 to the stop state (S16), and ends the process.

In this way, the communication device 10 switches the transformer circuit 24 to the stop state during the extraction period in which the wireless processing unit 21 extracts the positioning information from the signal of the radio wave transmitted from the GPS satellite. Thereby, in the communication device 10, radiation noise is not generated from the transformer circuit 24 during the extraction period, so that it is possible to suppress the degradation of the positioning performance.

Further, only when performing the positioning, the communication device 10 supplies power to the wireless processing unit 21 and the positioning unit 22 to switch the wireless processing unit 21 and the positioning unit 22 to the operating state, so that power is not supplied to the wireless processing unit 21 and the positioning unit 22 during a period in which the positioning is not performed. Therefore, the power consumption can be suppressed.

### [b] Second Embodiment

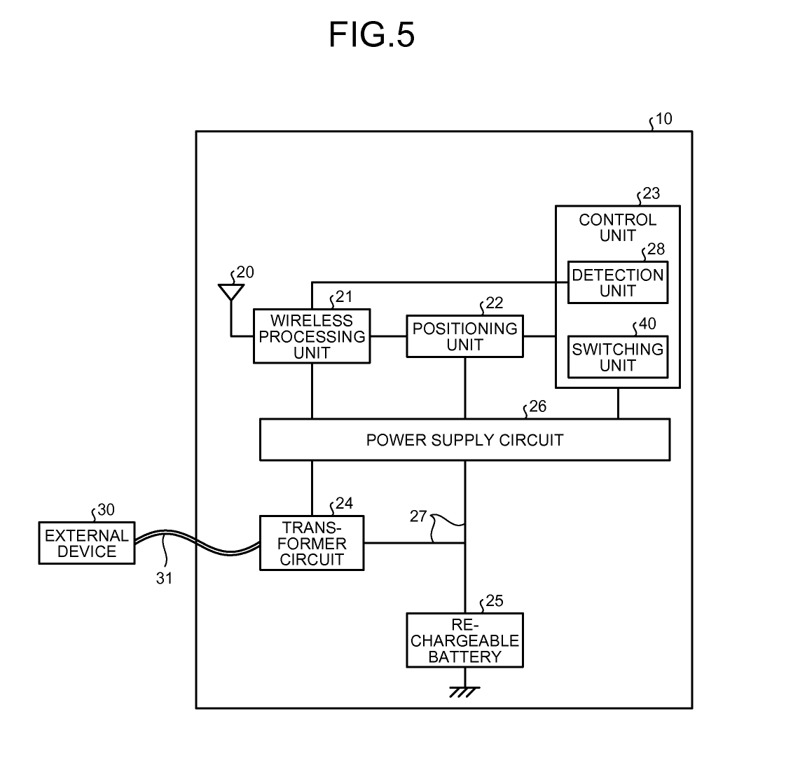

Next, a second embodiment will be described. FIG. 5 is a diagram illustrating an entire configuration of a communication device according to the second embodiment. The configuration of the communication device 10 according to the second embodiment is substantially the same as the communication device 10 according to the first embodiment illustrated in FIG. 1, so that the same components are denoted by the same reference numerals and different components will be mainly described.

As illustrated in FIG. 5, the control unit 23 of the communication device 10 further includes a detection unit 28.

The detection unit 28 performs various detections. For example, the detection unit 28 detects the receiver sensitivity of the radio wave. Here, it is not possible to simply determine the receiver sensitivity of the radio wave from a signal level of the signal of the radio wave inputted from the antenna 20. For example, if a large noise such as an electromagnetic noise is generated, the signal level of the signal of the radio wave inputted from the antenna 20 increases due to the influence of the noise. The wireless processing unit 21 identifies a phase control amount at a position where the digital data of the signal of the radio wave inputted from the antenna 20 and a code unique to the GPS satellite are similar to each other. However, when the digital data includes a large amount of noise, it may take time to identify the phase control amount. For example, when the digital data includes a large noise, the wireless processing unit 21 may take time to identify the position where the digital data and the unique code are similar to each other or may have difficulty in identifying the position. When the wireless processing unit 21 may have difficulty in identifying the position where the digital data and the unique code are similar to each other, the wireless processing unit 21 identifies again the position from the digital data of the signal of the radio wave newly received by the antenna 20. Therefore, when the digital data includes a large noise or the digital data includes a large amount of noise, the wireless processing unit 21 takes time to identify the phase control amount. When the wireless processing unit 21 takes time to identify the phase control amount, the wireless processing unit 21 also takes time to extract the positioning information.

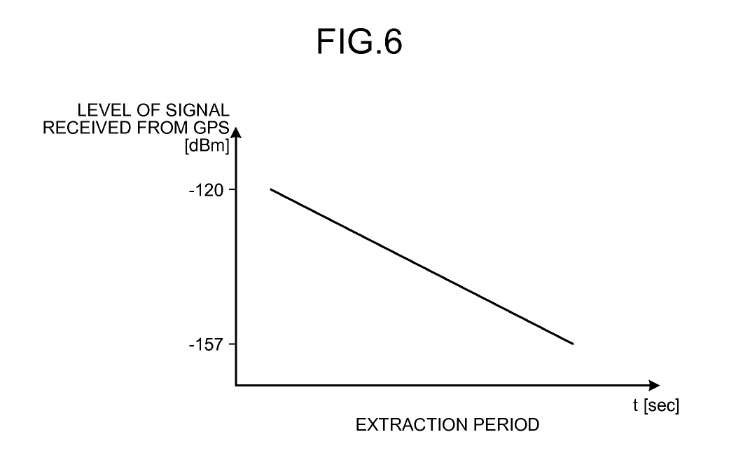

FIG. 6 is a graph schematically illustrating a relationship between the signal level of the signal of the radio wave inputted from the antenna and the extraction period of the positioning information. As illustrated in FIG. 6, the extraction period in which the wireless processing unit 21 extracts the positioning information depends on the signal level of the signal of the radio wave inputted into the wireless processing unit 21 and the extraction period is, for example, inversely proportional to the signal level. Therefore, the detection unit 28 measures the extraction period in which the wireless processing unit 21 extracts the positioning information. For example, the detection unit 28 measures a period from when the comparison of the unique code with the digital data is started to when a sufficient number of pieces of positioning information to perform positioning are extracted as the extraction period. Then, the detection unit 28 detects the receiver sensitivity from the extraction period by assuming that the longer the extraction period is, the lower the receiver sensitivity is. The receiver sensitivity may be defined in a stepwise manner, such as high, intermediate, and low, which indicate that the longer the extraction period is, the lower the receiver sensitivity is. The receiver sensitivity may be a continuous value according to the extraction period. The control unit 23 stores the receiver sensitivity detected by the detection unit 28 in a storage unit such as an internal memory not illustrated in the drawings.

When the receiver sensitivity detected by the detection unit 28 is lower than a predetermined acceptable level, the switching unit 40 according to the second embodiment switches the transformer circuit 24 to the stop state during the extraction period in which the wireless processing unit 21 extracts the positioning information. On the other hand, when the receiver sensitivity detected by the detection unit 28 is higher than or equal to the acceptable level, the switching unit 40 causes the transformer circuit 24 to operate and performs charging even during the extraction period in which the wireless processing unit 21 extracts the positioning information because the influence of the noise is decreased. The acceptable level is determined according to an acceptable degree of degradation of the positioning performance. The acceptable level may be a fixed value or a value that can be adjusted from outside.

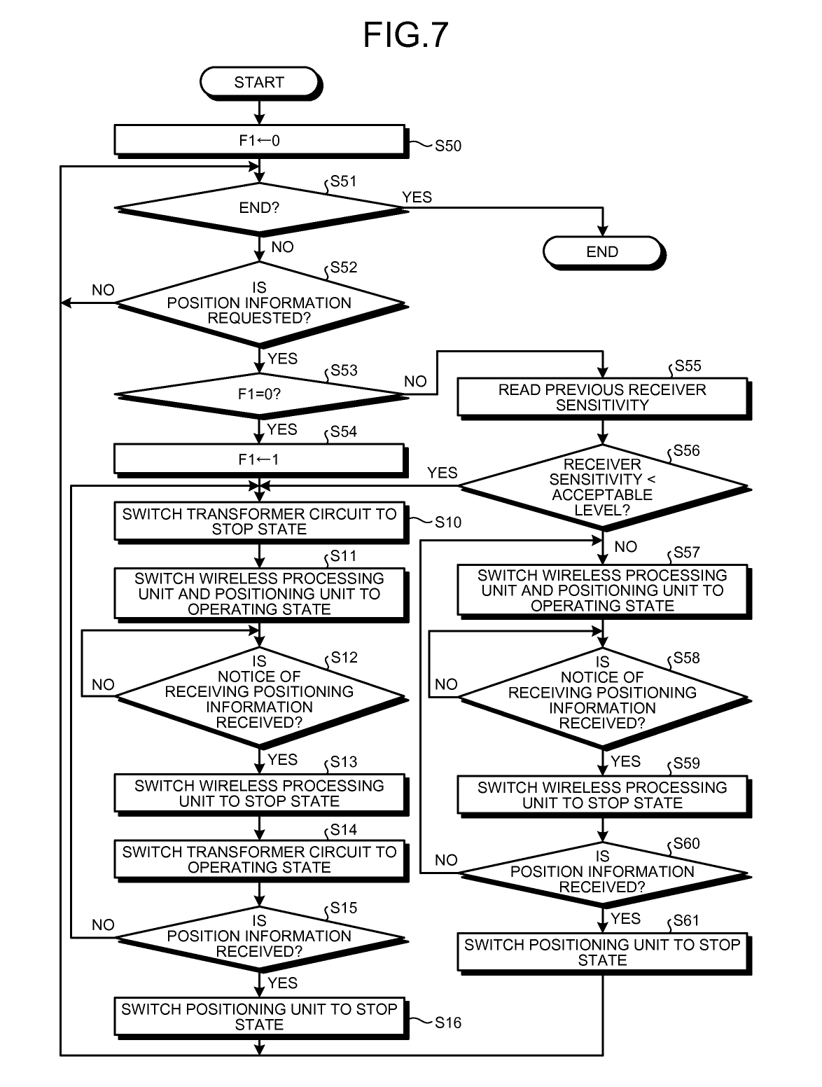

Next, a flow of a switching process will be described in which the communication device 10 according to the present embodiment switches the state of the transformer circuit 24. FIG. 7 is a flowchart illustrating a procedure of the switching process according to the second embodiment. The switching process is performed, for example, at a timing when an application program that requests the position information is started. The same processes as those in the switching process according to the first embodiment illustrated in FIG. 4 are denoted by the same reference numerals and different processes will be mainly described.

As illustrated in FIG. 7, the switching unit 40 initializes a flag F1, which stores information indicating whether or not it is the first positioning, to zero (S50). The switching unit 40 determines whether or not to end the process (S51). In the present embodiment, when the end of the process is instructed by the application program that requests the position information or when the process of the application program that requests the position information ends, the switching unit 40 determines to end the process. When the switching unit 40 determines to end the process (S51: Yes), the switching unit 40 ends the process.

On the other hand, when the switching unit 40 determines not to end the process (S51: No), the switching unit 40 determines whether or not the position information is requested by the application program (S52). If the position information is not requested (S52: No), the switching unit 40 proceeds to S51 described above.

On the other hand, if the position information is requested (S52: Yes), the switching unit 40 determines whether or not it is the first positioning according to whether or not the value of the flag F1 is zero (S53). If the value of the flag F1 is zero and it is the first positioning (S53: Yes), the switching unit 40 stores 1 in the flag F1 (S54). Then, the switching unit 40 performs the processes from S10 to S16 described above and thereafter proceeds to S51 described above. In other words, when performing the positioning, the switching unit 40 switches the wireless processing unit 21 and the positioning unit 22 to the operating state and after the completion of the processes of the wireless processing unit 21 and the positioning unit 22, the switching unit 40 switches the wireless processing unit 21 and the positioning unit 22 to the stop state. Further, the switching unit 40 switches the transformer circuit 24 to the stop state during the extraction period in which the positioning information is extracted. When performing the processes from S10 to S16, the detection unit 28 measures the extraction period in which the wireless processing unit 21 extracts the positioning information and detects the receiver sensitivity from the extraction period by assuming that the longer the extraction period is, the lower the receiver sensitivity is. Then the detection unit 28 outputs the detected receiver sensitivity to the control unit 23. The control unit 23 stores the received receiver sensitivity.

On the other hand, if the value of the flag F1 is other than zero and it is not the first positioning (S53: No), the switching unit 40 reads the receiver sensitivity at the time when the previous positioning information was extracted (S55). Then, the switching unit 40 determines whether or not the previous receiver sensitivity is lower than the acceptable level (S56). If the receiver sensitivity is lower than the acceptable level (S56: Yes), the switching unit 40 performs the processes from S10 to S16 described above and thereafter proceeds to S51 described above. In other words, when performing the positioning, the switching unit 40 switches the wireless processing unit 21 and the positioning unit 22 to the operating state and after the completion of the processes of the wireless processing unit 21 and the positioning unit 22, the switching unit 40 switches the wireless processing unit 21 and the positioning unit 22 to the stop state. Further, the switching unit 40 switches the transformer circuit 24 to the stop state during the extraction period in which the positioning information is extracted.

On the other hand, if the receiver sensitivity is not lower than the acceptable level (S56: No), the switching unit 40 instructs the power supply circuit 26 to supply power to the wireless processing unit 21 and the positioning unit 22 and switches the wireless processing unit 21 and the positioning unit 22 to the operating state (S57). Then, the switching unit 40 determines whether or not a notice of receiving the positioning information is received from the positioning unit 22 (S58). If the notice of receiving the positioning information is not received (S58: No), the switching unit 40 proceeds to S58 again and waits for a notice of receiving the positioning information. On the other hand, if the notice of receiving the positioning information is received (S58: Yes), the switching unit 40 instructs the power supply circuit 26 to stop the power supply to the wireless processing unit 21 and switches the wireless processing unit 21 to the stop state (S59). Then, the switching unit 40 determines whether or not the position information is received from the positioning unit 22 (S60). If the position information is not received (S60: No), the switching unit 40 proceeds to S57 described above. On the other hand, if the position information is received (S60: Yes), the switching unit 40 instructs the power supply circuit 26 to stop the power supply to the positioning unit 22 and switches the positioning unit 22 to the stop state (S61), and thereafter proceeds to S51 described above. In other words, while the switching unit 40 maintains the operating state of the transformer circuit 24, when performing the positioning, the switching unit 40 switches the wireless processing unit 21 and the positioning unit 22 to the operating state, and after the completion of the processes of the wireless processing unit 21 and the positioning unit 22, the switching unit 40 switches the wireless processing unit 21 and the positioning unit 22 to the stop state. Also, when performing the processes from S57 to S61, the detection unit 28 measures the extraction period in which the wireless processing unit 21 extracts the positioning information and detects the receiver sensitivity from the extraction period. Then the detection unit 28 outputs the detected receiver sensitivity to the control unit 23. The control unit 23 stores the received receiver sensitivity. The stored receiver sensitivity is used for the next determination in S56.

In this way, the communication device 10 detects the receiver sensitivity of the radio wave. When the receiver sensitivity is lower than the acceptable level, the communication device 10 switches the transformer circuit 24 to the stop state during the extraction period. Thereby, in the communication device 10, when the receiver sensitivity is lower than the acceptable level, radiation noise is not generated from the transformer circuit 24 during the extraction period, so that it is possible to suppress the degradation of the positioning performance. When the receiver sensitivity is not lower than the acceptable level, the communication device 10 does not switch the transformer circuit 24 to the stop state, so that it is possible to quickly charge the rechargeable battery 25.

The communication device 10 detects that the longer the extraction period is, the lower the receiver sensitivity is. Thereby, even when a noise of a large signal level is included in the signal of the radio wave, the communication device 10 can accurately detect the receiver sensitivity.

### [c] Third Embodiment

Next, a third embodiment will be described. The configuration of the communication device 10 according to the third embodiment is substantially the same as the communication device 10 according to the second embodiment illustrated in FIG. 5, so that different components will be mainly described.

The detection unit 28 according to the third embodiment measures the extraction period in which the wireless processing unit 21 extracts the positioning information and outputs the measured extraction period to the control unit 23. The control unit 23 stores the extraction period in a storage unit such as an internal memory not illustrated in the drawings.

The switching unit 40 according to the third embodiment determines whether or not to switch the transformer circuit 24 to the stop state during the extraction period by using the extraction period measured by the detection unit 28. In the switching unit 40, a first period T1 and a second period T2 shorter than the first period T1 are defined as threshold values to determine whether or not to switch the transformer circuit 24 to the stop state during the extraction period. When the extraction period measured by the detection unit 28 is longer than the first period T1, the switching unit 40 makes a setting to switch the transformer circuit 24 to the stop state during the extraction period and switches the transformer circuit 24 to the stop state during the extraction period. When the extraction period becomes shorter than the second period T2 after the setting to switch the transformer circuit 24 to the stop state during the extraction period is made, the switching unit 40 makes a setting to switch the transformer circuit 24 to the operating state and maintains the operating state of the transformer circuit 24 during the extraction period.

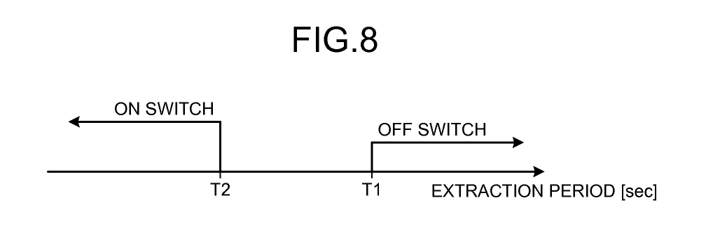

FIG. 8 is a diagram for explaining the determination of the switching. The horizontal axis in FIG. 8 represents the extraction period. When the extraction period becomes longer than the first period T1, the switching unit 40 makes a setting to switch the transformer circuit 24 to the stop state during the extraction period and switches the transformer circuit 24 to the stop state during the extraction period even if the extraction period thereafter becomes longer than or equal to the second period T2 and shorter than or equal to the first period T1. On the other hand, when the extraction period once becomes shorter than the second period T2, the switching unit 40 makes a setting to switch the transformer circuit 24 to the operating state during the extraction period and maintains the operating state of the transformer circuit 24 during the extraction period even if the extraction period thereafter becomes longer than or equal to the second period T2 and shorter than or equal to the first period T1. In this way, in the switching unit 40 according to the third embodiment, the threshold value to switch the transformer circuit 24 to the stop state during the extraction period and the threshold value to switch the transformer circuit 24 to the operating state during the extraction period are separately provided. Thereby, even when the extraction period changes around the first period T1 or around the second period T2, it is possible to suppress the frequent change of the setting whether to set the extraction period to the stop state or the operating state.

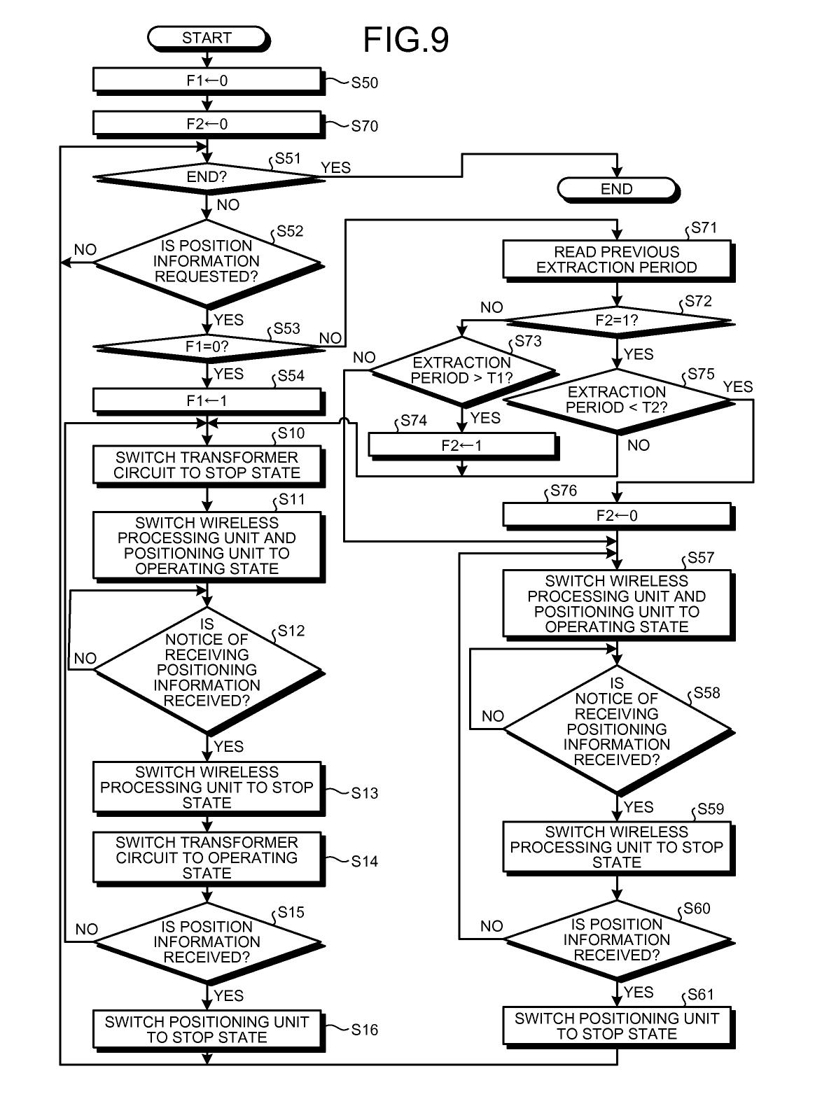

FIG. 9 is a flowchart illustrating a procedure of the switching process according to the third embodiment. The same processes as those in the switching process according to the second embodiment illustrated in FIG. 7 are denoted by the same reference numerals and different processes will be mainly described.

As illustrated in FIG. 9, the switching unit 40 initializes a flag F2, which stores a setting state of the switching, to zero (S70). In the flag F2, 1 is stored when the transformer circuit 24 is set to the operating state even during the extraction period. In the switching process illustrated in FIG. 9, in the case of the first positioning, zero is stored in the flag F2, so that the switching unit 40 performs the processes from S51 to S54 and from S10 to S16 described above and thereafter proceeds to S51 described above. In other words, when performing the positioning, the switching unit 40 switches the wireless processing unit 21 and the positioning unit 22 to the operating state and after the completion of the processes of the wireless processing unit 21 and the positioning unit 22, the switching unit 40 switches the wireless processing unit 21 and the positioning unit 22 to the stop state. Further, the switching unit 40 switches the transformer circuit 24 to the stop state during the extraction period in which the positioning information is extracted. When performing the processes from S10 to S16, the detection unit 28 measures the extraction period in which the wireless processing unit 21 extracts the positioning information. Then the detection unit 28 outputs the detected extraction period to the control unit 23. The control unit 23 stores the received extraction period.

In the switching process illustrated in FIG. 9, if the value of the flag F1 is other than zero and it is not the first positioning (S53: No), the switching unit 40 reads the extraction period when the previous positioning information was extracted (S71). Then, the switching unit 40 determines whether or not the value of the flag F2 is 1 (S72). If the value of the flag F2 is other than 1 (S72: No), the switching unit 40 determines whether or not the previous extraction period is longer than the first period T1 (S73). If the previous extraction period is longer than the first period T1 (S73: Yes), the switching unit 40 stores 1 in the flag F2 (S74) and performs the processes from S10 to S16, and thereafter proceeds to S51 described above. On the other hand, if the previous extraction period is not longer than the first period T1 (S73: No), the switching unit 40 performs the processes from S57 to S61 described above and thereafter proceeds to S51 described above.

On the other hand, if the value of the flag F2 is 1 (S72: Yes), the switching unit 40 determines whether or not the previous extraction period is shorter than the second period T2 (S75). On the other hand, if the previous extraction period is shorter than the second period T2 (S75: Yes), the switching unit 40 stores zero in the flag F2 (S76) and performs the processes from S57 to S61, and thereafter proceeds to S51 described above. On the other hand, if the previous extraction period is not shorter than the second period T2 (S75: No), the switching unit 40 performs the processes from S10 to S16 described above and thereafter proceeds to S51 described above.

In summary, if the extraction period is longer than the first period T1, the switching unit 40 stores 1 in the flag F2 and if the extraction period is shorter than the second period T2, the switching unit 40 stores zero in the flag F2. When the value of the flag F2 becomes 1, the switching unit 40 sets the transformer circuit 24 to the stop state during the extraction period until the extraction period becomes shorter than the second period T2. When the value of the flag F2 becomes zero, the switching unit 40 sets the transformer circuit 24 to the operating state during the extraction period until the extraction period becomes longer than the first period T1.

In this way, when the extraction period is longer than the first period T1, the communication device 10 makes a setting to switch the transformer circuit 24 to the stop state during the extraction period. When the extraction period becomes shorter than the second period T2 shorter than the first period T1 after the setting to switch the transformer circuit 24 to the stop state is made, the communication device 10 makes a setting to switch the transformer circuit 24 to the operating state. Thereby, even when the extraction period changes around the first period T1 or around the second period T2, the communication device 10 can suppress the frequent change of the setting whether to set the extraction period to the stop state or the operating state.

### [d] Fourth Embodiment

Although the embodiments related to the disclosed device have been described, the disclosed technique may be also implemented in various different forms other than the embodiments described above. Therefore, hereinafter, other embodiments included in the present invention will be described.

For example, in the above embodiments, examples in which the wireless processing unit 21 and the positioning unit 22 are separately provided are described. However, the disclosed device is not limited to this. For example, the wireless processing unit 21 and the positioning unit 22 may be one device. The positioning unit 22 may be implemented as software running on the control unit 23.

In the second and the third embodiments described above, a case is described in which whether or not to stop the wireless processing unit 21 during the present extraction period is determined by using the previous receiver sensitivity and the previous extraction period. However, the disclosed device is not limited to this. For example, whether or not to stop the wireless processing unit 21 during the present extraction period may be determined by using a plurality of previous receiver sensitivities and previous extraction periods. For example, a plurality of previous receiver sensitivities and previous extraction periods are averaged and the determination may be performed by using the average values.

In the second and the third embodiments described above, a case is described in which whether or not to stop the wireless processing unit 21 during the present extraction period is determined by using the previous receiver sensitivity and the previous extraction period. However, the disclosed device is not limited to this. For example, if it is once determined to stop the wireless processing unit 21 during the extraction period, thereafter the wireless processing unit 21 may be stopped in the extraction period for a predetermined number of times.

The respective components of the devices illustrated in the drawings are functionally conceptual, and need not necessarily be physically configured as illustrated in the drawings. In other words, specific forms of distribution and integration of the devices are not limited to those illustrated in the drawings, and all or part of the devices can be functionally or physically distributed or integrated in arbitrary units according to various loads and the state of use. For example, the processing units including the wireless processing unit 21, the positioning unit 22, the detection unit 28, and the switching unit 40 illustrated in FIGS. 1 and 3 may be appropriately integrated. All or any part of the processing functions performed in each processing unit can be realized by a CPU and a program analyzed and executed by the CPU, or can be realized as hardware by wired logic.

Switching Program

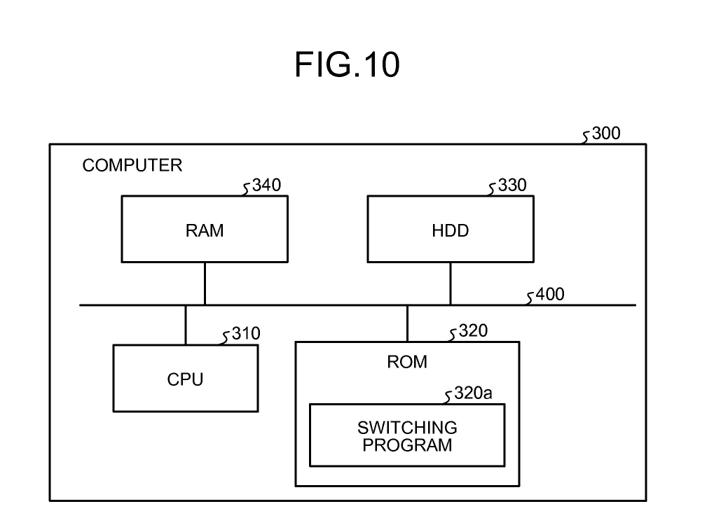

The various processing described in the above embodiments can be realized by executing a program prepared in advance by a computer system such as a personal computer or a workstation. Therefore, hereinafter, an example of a computer system that executes a program having the same function as that of the embodiments described above will be described. FIG. 10 is a diagram illustrating a computer that executes a switching program.

As illustrated in FIG. 10, a computer 300 includes a CPU 310, a Read Only Memory (ROM) 320, a Hard Disk Drive (HDD) 330, and a Random Access Memory (RAM) 340. Each component 310 to 340 is connected to each other through a bus 400.

A switching program 320a that exerts the same function as that of each processing unit in the embodiments described above is stored in advance in the ROM 320. For example, the switching program 320a that exerts the same function as that of the switching unit 40 in the embodiments described above is stored. The switching program 320a may be appropriately divided.

The HDD 330 stores various data. For example, the HDD 330 stores various data such as an OS and analysis data.

The CPU 310 reads the switching program 320a from the ROM 320 and executes the switching program 320a, so that the CPU 310 performs the same operation as that of each processing unit in the embodiments. In other words, the switching program 320a performs the same operation as that of the switching unit 40 in the embodiments.

The switching program 320a described above need not necessarily be stored in the ROM 320 from the beginning. The switching program 320a may be stored in the HDD 330.

For example, the program is stored in a “portable physical medium” such as a flexible disk (FD), a Compact Disk Read Only Memory (CD-ROM), a Digital Versatile Disk (DVD), a magneto-optical disk, and an IC card, which are inserted in the computer 300. Then, the computer 300 may read the program from these media and execute the program.

Further, the program is stored in “another computer (or server)” connected to the computer 300 through a public line, the Internet, a LAN, a WAN, or the like. Then, the computer 300 may read the program from the other computer or server and execute the program.

According to an aspect of the invention, it is possible to suppress the degradation of the positioning performance.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
an antenna that receives a radio wave transmitted from a GPS satellite;
an extraction unit that extracts positioning information from a signal of the radio wave received by the antenna;
a positioning unit that performs positioning on the basis of the positioning information extracted by the extraction unit;
a transformer circuit that includes a switching element and transforms supplied power to a predetermined voltage; and
a switching unit that switches the transformer circuit to a stop state during an extraction period in which the positioning information is extracted by the extraction unit.

2. The communication device according to claim 1, further comprising:
a detection unit that detects a receiver sensitivity of the radio wave,
wherein when the receiver sensitivity detected by the detection unit is lower than a predetermined acceptable level, the switching unit switches the transformer circuit to the stop state during the extraction period.

3. The communication device according to claim 2, wherein
the detection unit detects that the longer the extraction period is, the lower the receiver sensitivity is.

4. The communication device according to claim 2, wherein
when the extraction period is longer than a predetermined first period, the switching unit makes a setting to switch the transformer circuit to the stop state during the extraction period, and when the extraction period becomes shorter than a predetermined second period shorter than the first period after the setting to switch the transformer circuit to the stop state is made, the switching unit makes a setting to switch the transformer circuit to an operating state.

5. A computer-readable recording medium having stored therein a switching program for causing a computer to execute a process, the process comprising:
extracting positioning information from a signal of radio wave received by an antenna;
switching a transformer circuit that includes a switching element and transforms supplied power to a predetermined voltage to a stop state during an extraction period in which positioning information is extracted.

6. A switching method comprising:
extracting, by a computer, positioning information from a signal of radio wave received by an antenna;
switching, by a computer, a transformer circuit that includes a switching element and transforms supplied power to a predetermined voltage to a stop state during an extraction period in which positioning information is extracted.
